(19) United States
(12) Patent Application Publication
(10) Pub. No.: US 2019/0355053 A1
(43) Pub. Date: Nov. 21, 2019

(54) METHOD, A DEVICE AND A SYSTEM OF A DISTRIBUTED FINANCIAL FLOWS AUDITING

(71) Applicant: Tidetime Sun Ltd., Chai Wan (HK)

(72) Inventor: Gwan-Hwan Hwang, Hsinchu County 305 (TW)

(21) Appl. No.: 16/110,753

(22) Filed: Aug. 23, 2018

(30) Foreign Application Priority Data
May 18, 2018 (TW) 107117106

(51) Int. Cl. G06Q 40/02; G06Q 40/04; G06Q 20/38; G06Q 20/06

(52) U.S. Cl. CPC G06Q 40/02; G06Q 40/04; G06Q 20/06; G06Q 20/3825; G06Q 20/381

(57) ABSTRACT

The present invention provides a method, a device and a system of a distributed financial flows auditing. The distributed financial flows auditing method includes: providing a balance information of a physical currency exchange receipt or a balance information of a virtual currency related to an user and stored as a first indexed merkle tree, and providing a to-be-audited information of a trade related to the balance information and stored as a second indexed merkle tree; and the user compares the balance information and the to-be-audited information. The method further includes a communication protocol existed between the user and the market intermediary, an evidence protocol existed between the plurality of the users, and a settlement protocol existed at least between the first indexed merkle tree and the second indexed merkle tree when each of the stages is completed.

### FIELD OF THE INVENTION

The present invention is related to a field of the trade auditing, in particular, it is related to a method, a device and a system of a distributed financial flows auditing.

### BACKGROUND OF THE INVENTION

In the previous art of the blockchain embodiment, due to a to-be-audited information of a single cash flow trade is stored into the blockchain by the miners of the blockchain. Nowadays, a transaction broadband of a public blockchain used for the trade is too low (under 25 times per second). Meanwhile, because the currency value of the blockchain coin is increasing, cost of transaction fee of the cash flow in every trade is too high. Therefore, a general micropayment with blockchain is infeasible. Therefore the blockchain is generally used for the trade in order to facilitate the speed of the cash flow and reduce the cost of the trade. Because an agent is responsible for charging the user, recording and counting an account book, an account record is provided to a creditor in every period in order to inform a trade record, a corresponding royalty payment etc. during the present period. However the account book as mentioned above is recorded and maintained by the agent, the creditor and/or the user cannot audit the authenticity thereof. For example, the agent may not have the intent but some defect is happened in the system resulting in a shortage or the other fault of the record, and/or the agent may have the intent on forging or falsifying the record in order to reduce the royalty payment should be paid for the creditor.

Furthermore, the agent may claim that some downloads are obtained utilizing cracking or other ways by an unscrupulous user in the condition that the creditor and/or the user cannot auditing the authenticity of the account book. Besides, it may damage the right of the creditor and/or the user, even it may reduce the will that the creditor and/or the user delegate the authority of agency to the agent. Therefore it is disadvantageous for the improvement of the blockchain trade.

In view of this, a method, a device and a system of a distributed financial flows auditing are provided in the present invention in order to solve the problems of the blockchain embodiment in the previous art. In addition, the present invention is able to reduce the trade cost, to promote a credibility of the trade and to achieve a low-burden and high efficiency, and the present invention is able to support a general micropayments used for the physical currency exchange receipt or the virtual currency.

### SUMMARY OF THE INVENTION

The present invention provides a distributed financial flows auditing method comprising: providing a balance information of a physical currency exchange receipt or a balance information of a virtual currency related to an user and stored as a first indexed merkle tree, and providing a to-be-audited information of a trade related to the balance information and stored as a second indexed merkle tree; and the user compares the balance information and the to-be-audited information.

A distributed financial flows auditing method of the present invention, wherein, the to-be-audited information is at least corresponding to a contract.

A distributed financial flows auditing method of the present invention, wherein, the user trades with a market intermediary according to the contract, and the market intermediary updates the first indexed merkle tree and the second indexed merkle tree after the trade, an evidence information is created to the contract when a result comparing the balance information and the to-be-audited information by the user is abnormal.

A distributed financial flows auditing method of the present invention, wherein, a communication protocol is existed between the user and the market intermediary, and an evidence protocol is existed between the plurality of the users when the quantities of the users are plural, the market intermediary updates the first indexed merkle tree and the second indexed merkle tree by part of the quantities of the trades as a stage when the quantities of the trades are plural, and a settlement protocol is existed at least between the first indexed merkle tree and the second indexed merkle tree when each of the stages is completed.

A distributed financial flows auditing method of the present invention, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

A distributed financial flows auditing method of the present invention, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

A distributed financial flows auditing method of the present invention, wherein, the communication protocol includes a transfer trade, a deposit trade and a withdraw trade.

A distributed financial flows auditing method of the present invention, wherein, steps of the transfer trade include: the user transmits T_{Rmit}=((LSN, Remittance, Ui, Uj, X, stage serial number), SIG_{Pri(Ui)} to the market intermediary, LSN is an unrepeatable random number created by the user, SIG_{Pri(Ui)} is an electronic signature of a message body signed by the user; the market intermediary modifies the balance of the physical currency exchange receipt or the virtual currency of the different user(Ui,Uj) in the first indexed merkle tree, the balance of the physical currency exchange receipt or the virtual currency of Ui and Uj is assumed as p,q respectively after transferring; T_{ACK}=((T_{Rmit}, p, q, GSN), SIG_{Pri(Agent)}) is replied to the user Ui by the market intermediary, GSN is an integer created by the market intermediary and GSN is started from 0, GSN is added by 1 after every trade of the user is processed, SIG_{Pri(Agent)} is the electronic signature of the message body signed by the market intermediary; and the T_{ACK} is stored into the second indexed merkle tree by the market intermediary.

A distributed financial flows auditing method of the present invention, wherein, steps of the deposit trade include: the user(Ui) transmits T_{Deposit}=((LSN, Deposit, X, stage serial number), SIG_{Pri(Ui)} to the market intermediary, LSN is an unrepeatable random number created by the user, SIG_{Pri(Ui)} is an electronic signature of a message body signed by the user; the market intermediary modifies the balance of the user in the first indexed merkle tree, the balance of the physical currency exchange receipt or the virtual currency of the user is assumed as p after transferring; the market intermediary commands Deposit_token_to_sidechain( ) of the contract to be performed, Ui.balance of the contract is decreased by X by Deposit_token_to_sidechain( ) while a record:(Deposit, Ui, X, stage serial number, GSN) is added to the financial flows record; T_{ACK}=((T_{Deposit}, p, GSN), SIG_{Pri(Agent)})) is replied to the user by the market intermediary, GSN is an integer created by the market intermediary and GSN is started from 0, GSN is added by 1 after every trade of the user is processed, SIG_{Pri(Agent)} is the electronic signature of the message body signed by the market intermediary; and the T_{ACK} is stored into the second indexed merkle tree by the market intermediary.

A distributed financial flows auditing method of the present invention, wherein, steps of the withdraw trade include: the user(Ui) transmits T_{Withdraw}=((LSN, Withdraw, X, stage serial number), SIG_{Pri(Ui)} to the market intermediary, LSN is an unrepeatable random number created by the user, SIG_{Pri(Ui)} is an electronic signature of a message body signed by the user; the market intermediary modifies the balance of the user in the first indexed merkle tree, the balance of the physical currency exchange receipt or the virtual currency of the user is assumed as p after transferring; the market intermediary commands Withdraw_token_from_sidechain( ) of the contract to be performed, Ui.balance of the contract is added by X by Withdraw_token_from_sidechain( ) while a record: (Withdraw, Ui, X, stage serial number, GSN) is added to the financial flows record; T_{ACK}=((T_{Withdraw}, p, GSN), SIG_{Pri(Agent)}) is replied to the user by the market intermediary, GSN is an integer created by the market intermediary and GSN is started from 0, GSN is added by 1 after every trade of the user is processed, SIG_{Pri(Agent)} is the electronic signature of the message body signed by the market intermediary; and the T_{ACK} is stored into the second indexed merkle tree by the market intermediary.

A distributed financial flows auditing method of the present invention, wherein, the contract further includes a function Finalize( ), the market intermediary performs Finalize( ) in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

A distributed financial flows auditing method of the present invention, wherein, the contract has a function Fraud_proof( ) in order to create the evidence information, the evidence information is created in the following conditions or the combination thereof: (1) the market intermediary does not store the trade into the second indexed merkle tree after processing a transfer trade, a deposit trade or a withdraw trade, the user performs a Fraud_proof( ) function in order to extract T_{ACK} returned from the market intermediary and a slice of the second indexed merkle tree used for proving the market intermediary do not store the trade into the second indexed merkle tree; (2) the market intermediary calculates a wrong balance of the user after processing the transfer trades, the deposit trades or the withdraw trades, because GSN is existed in all T_{ACK} returned from the market intermediary in every trade and a GSN value is increasing and unrepeatable, the user sequences the plurality of the trades and finds out the returned T_{ACK} of the previous one trade from the market intermediary before the wrong trade, then the user performs Fraud_proof( ) function in order to create an evidence by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

A distributed financial flows auditing method of the present invention, wherein, the first indexed merkle tree and the second indexed merkle tree are corresponding to a blockchain.

The present invention provides a distributed financial flows auditing device comprising a processing unit and a storage unit, the processing unit creating a first indexed merkle tree related to an user, and the first indexed merkle tree is a balance information of a physical currency exchange receipt or a balance information of a virtual currency, and a second indexed merkle tree related to a to-be-audited information of a trade related to the balance information is created by the processing unit, and the balance information and the to-be-audited information are compared by the processing unit; and the storage unit coupling to the processing unit, and the first indexed merkle tree and the second indexed merkle tree are stored by the storage unit.

A distributed financial flows auditing device of the present invention, wherein, the to-be-audited information is at least corresponding to a contract, and the contract is processed by the processing unit, the contract is stored by the storage unit.

A distributed financial flows auditing device of the present invention, wherein, the user trades with a market intermediary according to the contract, and the market intermediary commands the processing unit to update the first indexed merkle tree and the second indexed merkle tree after the trade, an evidence information is created to the contract by the processing unit when a result comparing the balance information and the to-be-audited information by the processing unit the user commanded thereof is abnormal, and the evidence information is stored by the storage unit.

A distributed financial flows auditing device of the present invention, wherein, a communication protocol is existed between the user and the market intermediary, and an evidence protocol is existed between the plurality of the users when the quantities of the users are plural, the communication protocol and the evidence protocol are processed by the processing unit, and the communication protocol and the evidence protocol are stored by the storage unit, the first indexed merkle tree and the second indexed merkle tree are updated by the processing unit the market intermediary commands thereof in the condition a part of the quantities of the trades is a stage when the quantities of the trades are plural, the first indexed merkle tree and the second indexed merkle tree updated are stored by the storage unit, and a settlement protocol is existed at least between the first indexed merkle tree and the second indexed merkle tree when each of the stages is completed, the settlement protocol is processed by the processing unit and the settlement protocol is stored by the storage unit.

A distributed financial flows auditing device of the present invention, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

A distributed financial flows auditing device of the present invention, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

A distributed financial flows auditing device of the present invention, wherein, the communication protocol includes a transfer trade, a deposit trade and a withdraw trade.

A distributed financial flows auditing device of the present invention, wherein, steps of the transfer trade include: the processing unit is commanded to transmit T_{Rmit}=((LSN, Remittance, Ui, Uj, X, stage serial number), SIG_{Pri(Ui)} to the market intermediary by the user, LSN is an unrepeatable random number created by the user, SIG_{Pri(Ui)} is an electronic signature of a message body signed by the user; the processing unit is commanded to modify the balance of the physical currency exchange receipt or the virtual currency of the different user(Ui,Uj) in the first indexed merkle tree by the market intermediary, the balance of the physical currency exchange receipt or the virtual currency of Ui and Uj is assumed as p,q respectively after transferring; the processing unit is commanded to reply T_{ACK}=((T_{Rmit}, p, q, GSN), SIG_{Pri(Agent)}) to the user Ui by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store the T_{ACK} into the second indexed merkle tree by the market intermediary.

A distributed financial flows auditing device of the present invention, wherein, steps of the deposit trade include: the processing unit is commanded to transmit T_{Deposit}=((LSN, Deposit, X, stage serial number), SIG_{Pri(Ui)} to the market intermediary by the user(Ui), LSN is an unrepeatable random number created by the user, SIG_{Pri(Ui)} is an electronic signature of a message body signed by the user; the processing unit is commanded to modify the balance of the user in the first indexed merkle tree by the market intermediary, the balance of the physical currency exchange receipt or the virtual currency of the user is assumed as p after transferring; the processing unit is commanded to perform Deposit_token_to_sidechain( ) of the contract by the market intermediary, Ui.balance of the contract is decreased by X by Deposit_token_to_sidechain( ) while a record:(Deposit, Ui, X, stage serial number, GSN) is added to the financial flows record; the processing unit is commanded to reply T_{ACK}=((T_{Deposit}, p, GSN), SIG_{Pri(Agent)})) to the user by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store T_{ACK} into the second indexed merkle tree by the market intermediary.

A distributed financial flows auditing device of the present invention, wherein, steps of the withdraw trade include: the processing unit is commanded to transmit T_{Withdraw}=((LSN, Withdraw, X, stage serial number), SIG_{Pri(Ui)}) to the market intermediary by the user(Ui), LSN is an unrepeatable random number created by the user, SIG_{Pri(Ui)} is an electronic signature of a message body signed by the user; the processing unit is commanded to modify the balance of the user in the first indexed merkle tree by the market intermediary, the balance of the physical currency exchange receipt or the virtual currency of the user is assumed as p after transferring; the processing unit is commanded to perform Withdraw_token_from_sidechain( ) of the contract by the market intermediary, Ui.balance of the contract is added by X by Withdraw_token_from_sidechain( ) while a record: (Withdraw, Ui, X, stage serial number, GSN) is added to the financial flows record; the processing unit is commanded to reply T_{ACK}=((T_{Withdraw}, p, GSN), SIG_{Pri(Agent)}) to the user by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store T_{ACK} into the second indexed merkle tree by the market intermediary.

A distributed financial flows auditing device of the present invention, wherein, the contract further includes a function Finalize( ), the processing unit is commanded to perform Finalize( ) by the market intermediary in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

A distributed financial flows auditing device of the present invention, wherein, the contract has a function Fraud_proof( ) in order to create the evidence information, the evidence information is created in the following conditions or the combination thereof: (1) the market intermediary does not store the trade into the second indexed merkle tree after a transfer trade, a deposit trades or a withdraw trades is processed by the processing unit, the processing unit is commanded to perform a Fraud_proof( ) function by the user in order to extract T_{ACK} returned from the market intermediary and a slice of the second indexed merkle tree used for proving the market intermediary do not store the trade into the second indexed merkle tree; (2) the market intermediary calculates a wrong balance of the user after the transfer trade, the deposit trade or the withdraw trade are processed by the processing unit, because GSN is existed in all T_{ACK} returned from the market intermediary in every trade and a GSN value is increasing and unrepeatable, the processing unit is commanded to sequence the plurality of the trades and find out the returned T_{ACK} of the previous one trade from the market intermediary by the user before the wrong trade, then the processing unit is commanded to perform Fraud_proof( ) function by the user, an evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

A distributed financial flows auditing device of the present invention, wherein, the first indexed merkle tree and the second indexed merkle tree are corresponding to a blockchain.

The present invention provides a distributed financial flows auditing system comprising a plurality of financial flows auditing devices, at least one of the plurality of financial flows auditing devices includes a processing unit or a storage unit, each one of the financial flows auditing devices has a data transmission unit, and a first indexed merkle tree related to an user is created by the at least one processing unit, and the first indexed merkle tree is a balance information of a physical currency exchange receipt or a balance information of a virtual currency, and a second indexed merkle tree related to a to-be-audited information of a trade related to the balance information is created by the at least one processing unit, and the balance information, the to-be-audited information or the combination thereof is compared by the at least one processing unit, and at least a part of a information corresponding to the first indexed merkle tree, at least a part of a information corresponding to the second indexed merkle tree, a comparison result between the balance information and the to-be-audited information and the combination thereof are transmitted by the data transmission unit, the storage unit is coupled to the processing unit or the data transmission unit in order to store the first indexed merkle tree or the second indexed merkle tree.

A distributed financial flows auditing system of the present invention, wherein, the to-be-audited information is at least corresponding to a contract, and the contract is processed by the at least one processing unit, the contract is stored by the at least one storage unit.

A distributed financial flows auditing system of the present invention, wherein, the user trades with a market intermediary according to the contract, and the market intermediary commands the at least one processing unit to update the first indexed merkle tree and the second indexed merkle tree after the trade, an evidence information is created to the contract by the at least one processing unit when a result comparing the balance information and the to-be-audited information by the at least one processing unit the user commanded thereof is abnormal, and the evidence information is stored by the at least one storage unit.

A distributed financial flows auditing system of the present invention, wherein, a communication protocol is existed between the user and the market intermediary, and an evidence protocol is existed between the plurality of the users when the quantities of the users are plural, the communication protocol and the evidence protocol are processed by the at least one processing unit, and the communication protocol and the evidence protocol are stored by the at least one storage unit, the first indexed merkle tree and the second indexed merkle tree are updated by the at least one processing unit the market intermediary commands thereof in the condition a part of the quantities of the trades is a stage when the quantities of the trades are plural, the first indexed merkle tree and the second indexed merkle tree updated are stored by the at least one storage unit, and a settlement protocol is existed at least between the first indexed merkle tree and the second indexed merkle tree when each of the stages is completed, the settlement protocol is processed by the at least one processing unit, and the settlement protocol is stored by the at least one storage unit.

A distributed financial flows auditing system of the present invention, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

A distributed financial flows auditing system of the present invention, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

A distributed financial flows auditing system of the present invention, wherein, the communication protocol includes a transfer trade, a deposit trade and a withdraw trade.

A distributed financial flows auditing system of the present invention, wherein, steps of the transfer trade include: the at least one processing unit is commanded to transmit T_{Rmit}=((LSN, Remittance, Ui, Uj, X, stage serial number), SIG_{Pri(Ui)}) to the market intermediary by the user, LSN is an unrepeatable random number created by the user, SIG_{Pri(Ui)} is an electronic signature of a message body signed by the user; the at least one processing unit is commanded to modify the balance of the physical currency exchange receipt or the virtual currency of the different user(Ui,Uj) in the first indexed merkle tree by the market intermediary, the balance of the physical currency exchange receipt or the virtual currency of Ui and Uj is assumed as p,q respectively after transferring; the at least one processing unit is commanded to reply T_{ACK}=((T_{Rmit}, p, q, GSN), SIG_{Pri(Agent)}) to the user Ui by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store the T_{ACK} into the second indexed merkle tree by the market intermediary.

A distributed financial flows auditing system of the present invention, wherein, the steps of the deposit trade include: the at least one processing unit is commanded to transmit T_{Deposit}=((LSN, Deposit, X, stage serial number), SIG_{Pri(Ui)}) to the market intermediary by the user(Ui), LSN is an unrepeatable random number created by the user, SIG_{Pri(Ui)} is an electronic signature of a message body signed by the user; the at least one processing unit is commanded to modify the balance of the user in the first indexed merkle tree by the market intermediary, the balance of the physical currency exchange receipt or the virtual currency of the user is assumed as p after transferring;

the at least one processing unit is commanded to perform Deposit_token_to_sidechain( ) of the contract by the market intermediary, Ui.balance of the contract is decreased by X by Deposit_token_to_sidechain( ) while a record:(Deposit, Ui, X, stage serial number, GSN) is added to the financial flows record; the at least one processing unit is commanded to reply T_{ACK}=((T_{Deposit}, p, GSN), SIG_{Pri(Agent)})) to the user by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store T_{ACK} into the second indexed merkle tree by the market intermediary.

A distributed financial flows auditing system of the present invention, wherein, the steps of the withdraw trade includes: the at least one processing unit is commanded to transmit T_{Withdraw}=((LSN, Withdraw, X, stage serial number), SIG_{Pri(Ui)} to the market intermediary by the user(Ui), LSN is an unrepeatable random number created by the user, SIG_{Pri(Ui)} is an electronic signature of a message body signed by the user; the at least one processing unit is commanded to modify the balance of the user in the first indexed merkle tree by the market intermediary, the balance of the physical currency exchange receipt or the virtual currency of the user is assumed as p after transferring; the at least one processing unit is commanded to perform Withdraw_token_from_sidechain( ) of the contract by the market intermediary, Ui.balance of the contract is added by X by Withdraw_token_from_sidechain( ) while a record: (Withdraw, Ui, X, stage serial number, GSN) is added to the financial flows record; the at least one processing unit is commanded to reply T_{ACK}=((T_{Withdraw}, p, GSN), SIG_{Pri(Agent)}) to the user by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store T_{ACK} into the second indexed merkle tree by the market intermediary.

A distributed financial flows auditing system of the present invention, wherein, the contract further includes a function Finalize( ) the at least one processing unit is commanded to perform Finalize( ) by the market intermediary in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

A distributed financial flows auditing system of the present invention, wherein, the contract has a function Fraud_proof( ) in order to create the evidence information, the evidence information is created in the following conditions or the combination thereof: (1) the market intermediary does not store the trade into the second indexed merkle tree after a transfer trade, a deposit trades or a withdraw trades is processed by the at least one processing unit, the at least one processing unit is commanded to perform a Fraud_proof( ) function by the user in order to extract T_{ACK} returned from the market intermediary and a slice of the second indexed merkle tree used for proving the market intermediary do not store the trade into the second indexed merkle tree; (2) the market intermediary calculates a wrong balance of the user after the transfer trade, the deposit trade or the withdraw trade are processed by the at least one processing unit, because GSN is existed in all T_{ACK} returned from the market intermediary in every trade and a GSN value is increasing and unrepeatable, the at least one processing unit is commanded to sequence the plurality of the trades and find out the returned T_{ACK} of the previous one trade from the market intermediary by the user before the wrong trade, then the at least one processing unit is commanded to perform Fraud_proof( ) function by the user, an evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

A distributed financial flows auditing system of the present invention further comprising a blockchain device or a blockchain unit, the blockchain device is coupled to the at least one financial flows auditing device, the blockchain unit is provided to the at least one financial flows auditing device, the first indexed merkle tree and the second indexed merkle tree is at least corresponding to a blockchain in the blockchain device or a blockchain in the blockchain unit.

Comparing to the previous art, the present invention is able to save the cost of time, frequency, fee etc. used for transmitting the to-be-audited information. Additionally, the present invention is able to promote a credibility of the trade. Furthermore, the present invention is able to achieve a low-burden and high efficiency system. In addition, the present invention can support a general micropayments used for the physical currency exchange receipt or the virtual currency.

### BRIEF DESCRIPTION OF THE DRAWINGS

FIG. 1 is a flow diagram of a distributed financial flows auditing method in the present invention.

FIG. 2 is a schematic view of a slice.

FIG. 3 is a block diagram of a contract content in the present invention.

FIG. 4 is a flow diagram of a transfer trade in the present invention.

FIG. 5 is a flow diagram of a deposit trade in the present invention.

FIG. 6 is a flow diagram of a withdraw trade in the present invention.

FIG. 7 is a block diagram of a distributed financial flows auditing device in the present invention.

FIG. 8 is a block diagram of a distributed financial flows auditing system in the present invention.

### DETAILED DESCRIPTION OF THE EMBODIMENTS

The following provides a detailed description of the embodiments along with the accompanied drawings to facilitate the understanding of the technical features and effects of the present invention.

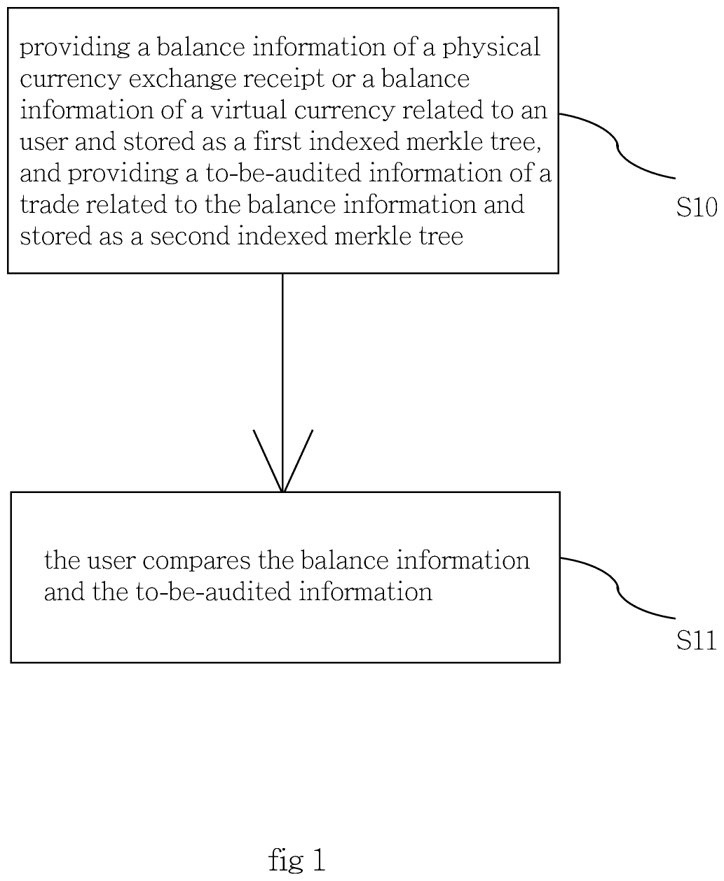

As shown in FIG. 1, it is a flow diagram of a distributed financial flows auditing method of the present invention, and the steps thereof comprise step S10 to step S11.

In the step S10, a balance information of a physical currency exchange receipt or a balance information of a virtual currency related to an user and stored as a first indexed merkle tree is provided, and a to-be-audited information of a trade related to the balance information and stored as a second indexed merkle tree, wherein the first indexed merkle tree and the second indexed merkle tree may be a combination of a Full Hash Binary Tree and a Index function Γ (i.e. Γ(FileName)=SHA-256(FileName) mod 2^{N-1}). But in the other embodiment, the other type of the hash tree is not limited to be used. The to-be-audited information may be related to user. In particular, the quantity of the user (user end) may be plural. Wherein, the to-be-audited information may be an account book for example, and the trade record may be recorded in the account book. In a different embodiment, the quantities of the users may be large, for example, in the cryptocurrency application, merchandise trade platform or labor service trade platform etc. 0.5 million users use. For example the physical currency exchange receipt may be a bankbook, bill, check, stock, title deed, electronic wallet etc., and the virtual currency may be Bitcoin, Ether etc. but the present invention is not limited. Furthermore, the to-be-audited information may be the integrated to-be-audited information of a plurality of trades, therefore this can save the cost of time, frequency, fee etc. used for transmitting the to-be-audited information. In particular, the first indexed merkle tree and the second indexed merkle tree of the present invention may be corresponding to a blockchain. The user may be a trader, a participant of the blockchain or the other participant.

Additionally, a condensed status code may be created by a using a hash function in accordance of the to-be-audited information. “MD5”, “RIPEMD160”, “SHA1”, “SHA256”, “SHA384”, “SHA512” or other hash functions may be utilized for the hash function. In a preferring embodiment, the “SHA” series hash function may be utilized, and in a more particular embodiment the “SHA256” hash function may be utilized. Accordingly, the condensed status code may be used for checking the integrity and identity of the to-be-audited information, and the condensed status code is irreversible such that the original data cannot be reversely obtained. Moreover, it is of the effect of a compressed file such that it is facilitated for transmission through condensation.

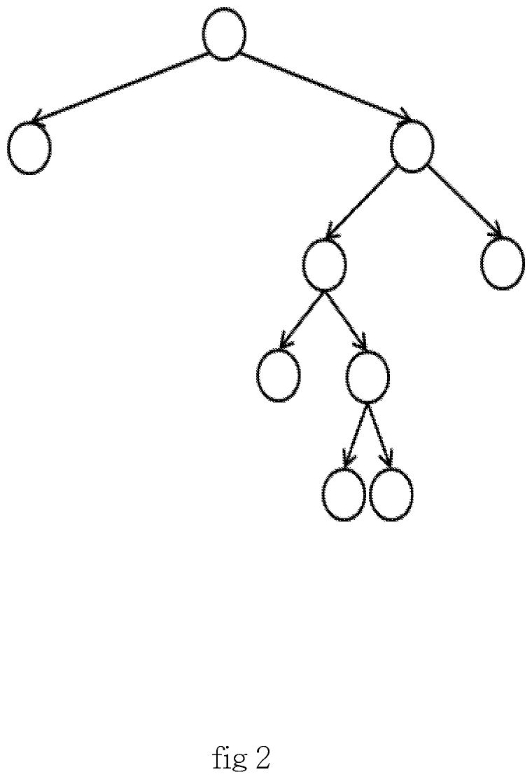

The first indexed merkle tree may include a first slice, and the second indexed merkle tree may include a second slice. In detail, the to-be-audited information may be divided to a plurality of slices. As shown in FIG. 2, it is a schematic view of the plurality of slices, and it can show a hash tree extracting a special part. Accordingly, a slice related to the user may be created in accordance with the user in the present invention. Therefore, the user only need to review a trade information related to himself by the respective slice. In additional, the to-be-audited information may be at least corresponding to a contract. For example, the contract may be a smart contract of an Ethereum, but the present invention is not limited.

In step S11, the user may compare the balance information and the to-be-audited information. When the user first deposits, the distributed financial flows auditing method of the present invention may only compare the balance information and the to-be-audited information of the first deposition. Particularly, comparing the balance information and the to-be-audited information may be comparing the first slice and the second slice. The user may trade with a market intermediary according to the contract, and the market intermediary updates the first indexed merkle tree and the second indexed merkle tree after the trade. An evidence (Fraud Proof) information is created to the contract when a result comparing the balance information and the to-be-audited information by the user is abnormal. The market intermediary may be an agent, a broker, a manager etc.

In detail, both of the condensed status code and the slice related to the trade of the user may be transmitted to the user, therefore the user is able to determine whether the slice is of identity based on the condensed status code in order to compare whether the trade information (account book) of the user is correct and to further determine whether to make feedbacks for errors. Accordingly, since the user only uses its own slice, and the user only compares whether his own trade information is correct. Furthermore, in an embodiment of the present invention, since the condensed status code is utilized such that there is identity, or uniqueness, between each slice and the to-be-audited information, consequently, a binding effect exists therebetween. As a result, as long as any one of the users makes a feedback for error, it is able to compare that the to-be-audited information in incorrect. In other words, the comparison work is distributed to each of the users. In addition, when each user is reviewing his own trade information, the user has also performed the comparison work at the same time without increasing the burden of each user. Furthermore, in a preferred embodiment, the confirmation action on the condensed status code and its slice can also be automatically performed by utilizing application program in each one of the user.

In an embodiment of the present invention, the utilization of the condensed status code and slice can greatly reduce the data transmission volume required. For example, in an embodiment, if there are 500,000 users (user ends), then the memory space required for the installation of hash tree is approximately 206.9 Megabytes (MB), whereas the user condensed status code requires the download size of only approximately 32 Byes (B) and receiving slice requires the download size of only 1 Kb. The download size is only approximately 1/100,000 of the original account book (to-be-audited information). In addition, under an ideal condition, the comparison requires only the duration of time of approximately 1/1,000 second. It is applicable to network platform (or known as the network sales platform, network service platform or other names) with large amount of users without obvious lag or improper user experience. Therefore, it is able to achieve a low-burden and high efficiency system. Additionally, in the present invention embodiment, since a collateral, for example the physical currency exchange receipt or virtual currency, may be provided to the contract, a compensation from the collateral may be paid to the user when a result comparing the balance information and the to-be-audited information by the user is abnormal, therefore a credibility of the present invention is promoted.

Further, a communication protocol is existed between the user of the distributed financial flows auditing method in the present invention and the market intermediary, and an evidence protocol is existed between the pluralities of the users when the quantities of the users are plural. The market intermediary updates the first indexed merkle tree and the second indexed merkle tree by part of the quantities of the trades as a stage when the quantities of the trades are pluralities. A settlement protocol is existed at least between the first indexed merkle tree and the second indexed merkle tree when each of the stages is completed. The communication protocol may include a transfer trade, a deposit trade and a withdraw trade. Therefore, a multiple to multiple trade channel between the plurality of the users and between the plurality of the users and the at least one market intermediary is created by these protocols in the present invention in order to support a general micropayments used for the physical currency exchange receipt or the virtual currency.

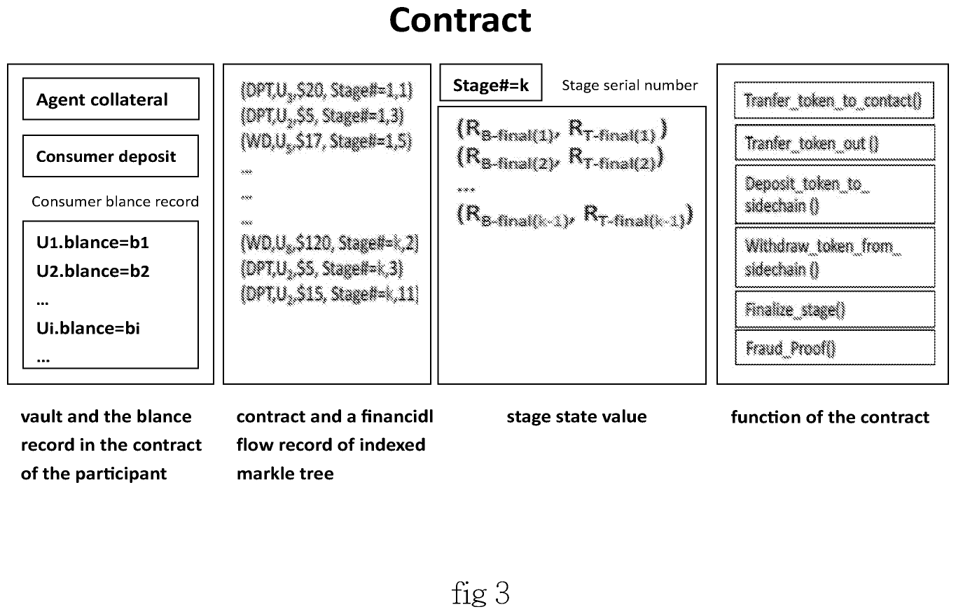

Please refer to FIG. 3, in detail, the contract may include a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

As mentioned above, the function of the contract may include a function depositing the physical currency exchange receipt or the virtual currency of the user to the contract (i.e. Transfer_token_to_contact( ). Particularly, the virtual currency owned by a financial flows trader is deposited to the smart contract), a function transferring the physical currency exchange receipt or the virtual currency of the user in the contract (i.e. Transfer_token_out( ). Particularly, the financial flows trader transfers his virtual currency in the contract into another account in the blockchain), a function transferring the physical currency exchange receipt or the virtual currency of the user in the contract to the first indexed merkle tree (i.e. Deposit_token_to_sidechain( )). Particularly, transferring the virtual currency of the financial flows trader in the contract to the first indexed merkle tree), a function transferring at least part of the balance of the physical currency exchange receipt or the virtual currency in the first indexed merkle tree to the contract (i.e. Withdraw_token_from_sidechain( )).

Particularly, a virtual currency balance of the first indexed merkle tree is transferred to the smart contract), a function completing the one stage and performing a settlement (i.e. Finalize( ). Particularly, the one stage is completed and a settlement is performed), and a function creating the evidence information (i.e. Fraud_Proof( )). But the present invention is not limited.

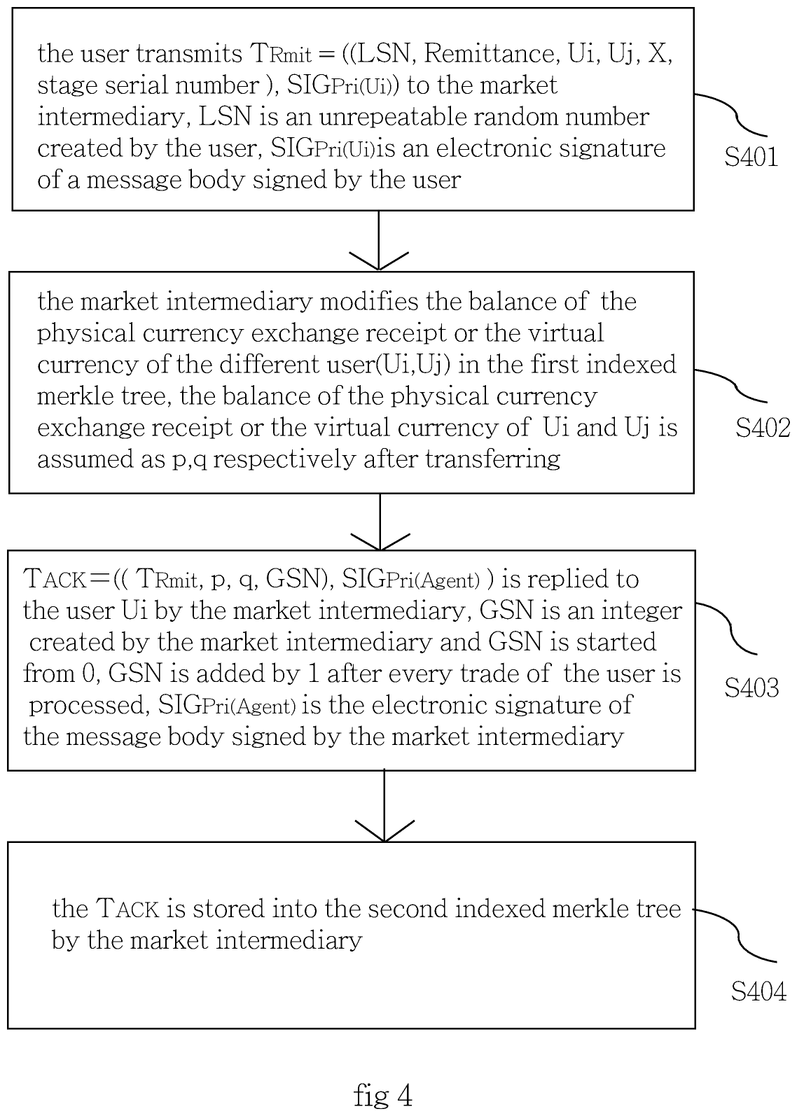

Please refer to FIG. 4, steps of the transfer trade as mentioned above (for example, trader (Ui) (or the user (Ui)) transfers X unit virtual currency to trader (Uj)) may include a following steps: step S401 to step S404, in the step S401, the user transmits T_{Rmit}=((LSN, Remittance, Ui, Uj, X, stage serial number), SIG_{Pri(Ui)} to the market intermediary, LSN is an unrepeatable random number created by the user, SIG_{Pri(Ui)} is an electronic signature of a message body signed by the user. Particularly, first a trade participant (the user (Ui)) transmits T_{Rmit}=((LSN, Remittance, Ui, Uj, X, stage serial number), SIG_{Pri(Ui)}) to agent (the market intermediary), wherein LSN(Local sequence number) is an unrepeatable random number created by the trader (the user (Ui)), and SIG_{Pri(Ui)} is an electronic signature of a message body signed by Ui. In step S402, the market intermediary modifies the balance of the physical currency exchange receipt or the virtual currency of the different user(Ui,Uj) in the first indexed merkle tree. The balance of the physical currency exchange receipt or the virtual currency of Ui and Uj is assumed as p and q respectively after transferring. Particularly, the agent modifies the balance of the virtual currency in the first indexed merkle tree of the trader Ui, Uj. The balances of the virtual currency of Ui and Uj are assumed as p and q respectively after transferring. In step S403, T_{ACK}=((T_{Rmit}, p, q, GSN), SIG_{Pri(Agent)}) is replied to the user Ui by the market intermediary, GSN is an integer created by the market intermediary and GSN is started from 0, GSN is added by 1 after every trade of the user is processed, SIG_{Pri(Agent)} is the electronic signature of the message body signed by the market intermediary. Particularly, the agent replies T_{ACK}=((T_{Rmit}, p, q, GSN), SIG_{Pri(Agent)}) to the trader Ui, wherein GSN (Global sequence number) is an integer created by the agent, and GSN is started from 0. GSN is added by 1 after every trade of the trader is processed. SIG_{Pri(Agent)} is the electronic signature of the message body signed by the market intermediary. In step S404, the T_{ACK} is stored into the second indexed merkle tree by the market intermediary.

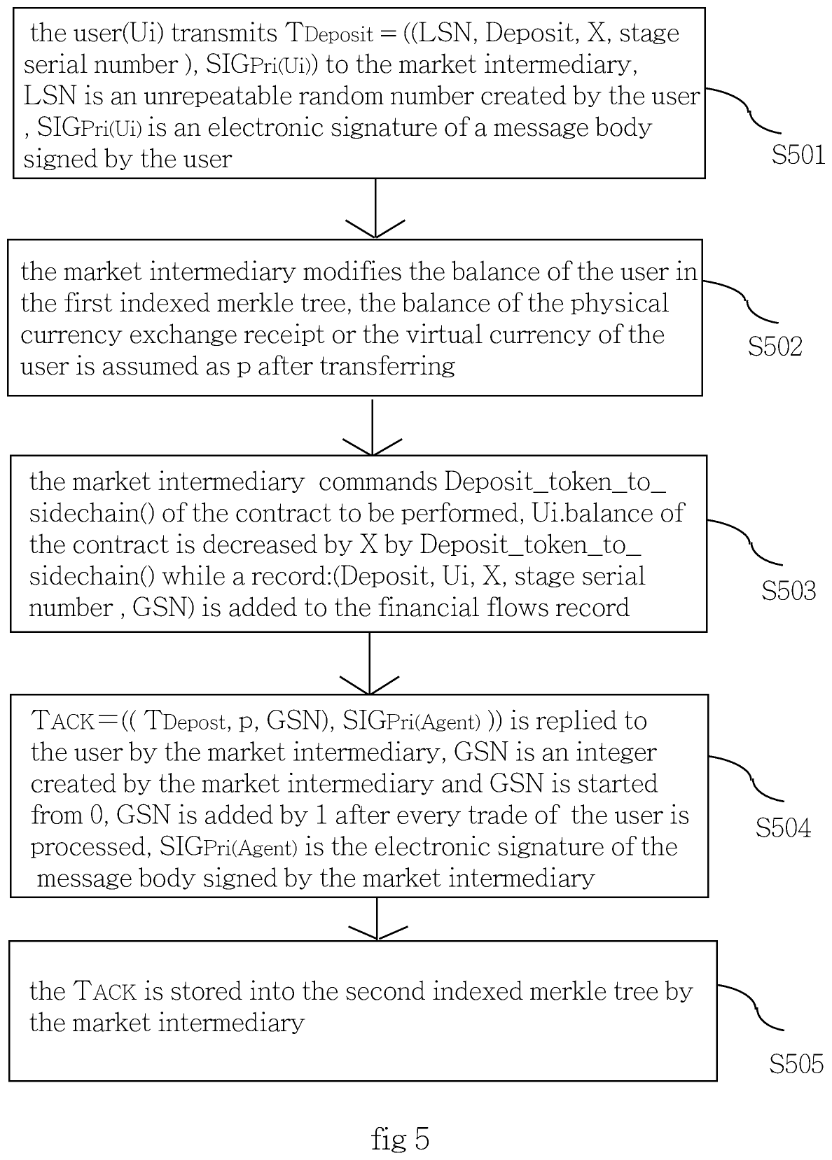

Please refer to FIG. 5, steps of the deposit trade as mentioned above (for example, the trader Ui transfer X unit virtual currency of the smart contract to the first indexed merkle tree) include the following steps: step S501 to step S505. In step S501, the user(Ui) transmits T_{Deposit}=((LSN, Deposit, X, stage serial number), SIG_{Pri(Ui)} to the market intermediary, LSN is an unrepeatable random number created by the user, SIG_{Pri(Ui)} is an electronic signature of a message body signed by the user. Particularly, first the trade participant Ui transmits T_{Deposit}=((LSN, Deposit, X, stage serial number), SIG_{Pri(Ui)} to the agent, wherein LSN (Local sequence number) is an unrepeatable random number created by the trader Ui, and SIG_{Pri(Ui)} is an electronic signature of a message body signed by Ui. In step S502, the market intermediary modifies the balance of the user in the first indexed merkle tree, and the balance of the physical currency exchange receipt or the virtual currency of the user is assumed as p after transferring. Particularly, the balance of the trader Ui in the first indexed merkle tree is modified (increases X) by the agent, and the balance of the trader Ui is assumed as p after transferring. In step S503, the market intermediary commands Deposit_token_to_sidechain( ) of the contract to be performed, Ui.balance of the contract is decreased by X by Deposit_token_to_sidechain( ) while a record:(Deposit, Ui, X, stage serial number, GSN) is added to the financial flows record. Particularly, the agent calls and perform Deposit_token_to_sidechain( ) of the smart contract, Ui.balance of the contract will be decreased by X through this function, while a record:(Deposit, Ui, X, stage serial number, GSN) is add to the financial flows record between the contract and a sidechain. In step S504, T_{ACK}=((T_{Deposit}, p, GSN), SIG_{Pri(Agent)})) is replied to the user by the market intermediary, GSN is an integer created by the market intermediary and GSN is started from 0, GSN is added by 1 after every trade of the user is processed, SIG_{Pri(Agent)} is the electronic signature of the message body signed by the market intermediary. Particularly, the agent reply T_{ACK}=((T_{Deposit}, p, GSN), SIG_{Pri(Agent)}) to the trader Ui, wherein GSN is an integer created by the agent and GSN is started from 0. GSN is added by 1 after every trade of the trader is processed. SIG_{Pri(Agent)} is the electronic signature of the message body signed by the market intermediary. In step S505, the T_{ACK} is stored into the second indexed merkle tree by the market intermediary.

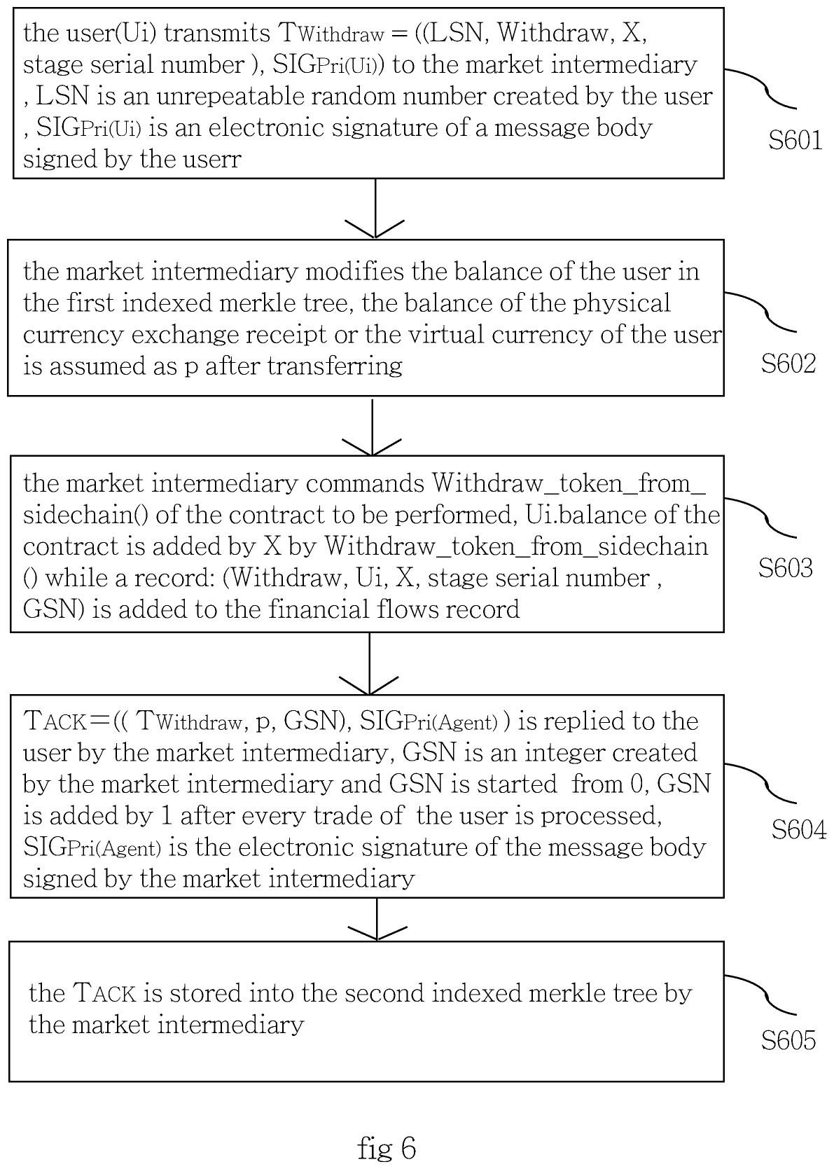

Please refer to FIG. 6, steps of the withdraw trade as mentioned above (for example, the trader Ui transfer X unit virtual currency of the first indexed merkle tree to the smart contract) include the following steps: step S601 to step S605. In step S601, the user(Ui) transmits T_{Withdraw}=((LSN, Withdraw, X, stage serial number), SIG_{Pri(Ui)}) to the market intermediary, LSN is an unrepeatable random number created by the user, SIG_{Pri(Ui)} is an electronic signature of a message body signed by the user. Particularly, trade participant Ui transmits T_{Withdraw}=((LSN, Withdraw, X, stage serial number), SIG_{Pri(Ui)} to the agent, wherein LSN (Local sequence number) is an unrepeatable random number created by the trader Ui. SIG_{Pri(Ui)} is an electronic signature of a message body signed by Ui. In step S602, the market intermediary modifies the balance of the user in the first indexed merkle tree, the balance of the physical currency exchange receipt or the virtual currency of the user is assumed as p after transferring. Particularly, the balance of the trader Ui in the first indexed merkle tree is modified (decreased by X) by the agent. The balance of Ui is assumed as p. In step S603, the market intermediary commands Withdraw_token_from_sidechain( ) of the contract to be performed, Ui.balance of the contract is added by X by Withdraw_token_from_sidechain( ) while a record: (Withdraw, Ui, X, stage serial number, GSN) is added to the financial flows record. Particularly, the agent calls and performs Withdraw_token_from_sidechain( ) of the smart contract, and Ui.balance of the contract is added by X by this function, while a record (Withdraw, Ui, X, stage serial number, GSN) is added to the financial flows record between the contract and the sidechain (first and/or second indexed merkle tree). In step S604, T_{ACK}=((T_{Withdraw}, p, GSN), SIG_{Pri(Agent)}) is replied to the user by the market intermediary, GSN is an integer created by the market intermediary and GSN is started from 0, GSN is added by 1 after every trade of the user is processed, SIG_{Pri(Agent)} is the electronic signature of the message body signed by the market intermediary. Particularly, the agent replies T_{ACK}=((T_{Withdraw}, p, GSN), SIG_{Pri(Agent)}) to the trader Ui, wherein GSN is an integer created by the agent and GSN is started from 0. GSN is added by 1 after every trade of the trader is processed, and SIG_{Pri(Agent)} is the electronic signature of the message body signed by the market intermediary. In step S605, T_{ACK} is stored into the second indexed merkle tree by the market intermediary.

Further, updating the first indexed merkle tree and the second indexed merkle tree by the market intermediary may include creating a first root hash value (Root Hash) corresponding to the first indexed merkle tree and a second root hash value corresponding to the second indexed merkle tree, and the market intermediary updates the contract by the first root hash value and the second root hash value.

Additionally, the contract further includes a function Finalize( ), wherein the market intermediary performs Finalize( ) in order to store a hash value of the first indexed merkle tree and the second indexed merkle tree into the contract and publish after a present stage is completed, while the market intermediary publishes at least a part of the first indexed merkle tree and at least a part of the second indexed merkle tree used for query after the present stage is completed. Particularly, a function Finalize( ) of the smart contract is a settlement protocol operated after an promised time is matured. Therefore, a distributed financial flows auditing method of the present invention can integrate and settle the trades in a period of time in order to save the cost of time, frequency, fee etc used for transmitting the to-be-audited information. The agent perform this function in order to store a hash value of the first indexed merkle tree and the second indexed merkle tree into the contract and publish after the present stage is completed. While the agent also publishes at least a part of the first indexed merkle tree and at least a part of the second indexed merkle tree used for query after the present stage is completed.

Furthermore, the contract may have a function Fraud_proof( ) in order to create the evidence information. The evidence information is created in the following conditions or the combination thereof: (1) the market intermediary does not store the trade in the second indexed merkle tree after processing a transfer trade, a deposit trade or a withdraw trade, the user performs a Fraud_proof( ) function in order to extract T_{ACK} returned from the market intermediary and a slice of the second indexed merkle tree used for proving the market intermediary do not store the trade in the second indexed merkle tree; (2) the market intermediary calculates a wrong balance of the user after processing the transfer trades, the deposit trades or the withdraw trades, and because GSN is existed in all T_{ACK} returned from the market intermediary in every trade and a GSN value is increasing and unrepeatable, the user sequences the plurality of the trades and finds out the returned T_{ACK} of the previous one trade from the market intermediary before the wrong trade, then the user performs Fraud_proof( ) function in order to create an evidence by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed. Particularly, in a purpose for proving the agent is failed, an cryptography evidence is extract by the trader or the other participant in accordance with the function Fraud_proof( ) of the smart contract. The following condition may be happened: (1) the agent does not store the trade in the second indexed merkle tree after processing a transfer trade, a deposit trade or a withdraw trade, and the trader or the other participant may perform the Fraud_proof( ) function in order to extract T_{ACK} returned from the agent and a slice of the second indexed merkle tree used for proving the agent do not store the trade in the second indexed merkle tree. (2) the agent calculates a wrong balance of the trader after processing the transfer trades, the deposit trades or the withdraw trades. Because GSN is existed in all T_{ACK} returned from the agent in every trade and a GSN value is increasing and unrepeatable, the trader sequences his own trades and finds out the returned T_{ACK} of the previous one trade from the agent before the wrong trade. Then the trader performs Fraud_proof( ) function in order to create an evidence by the wrong trade and the returned trade information in the previous one trade. Because the agent cannot extract an evidence used for prove there is no GSN value of a trade between the GSN value of the present trade and the GSN value of the previous one trade, the agent failure is proved.

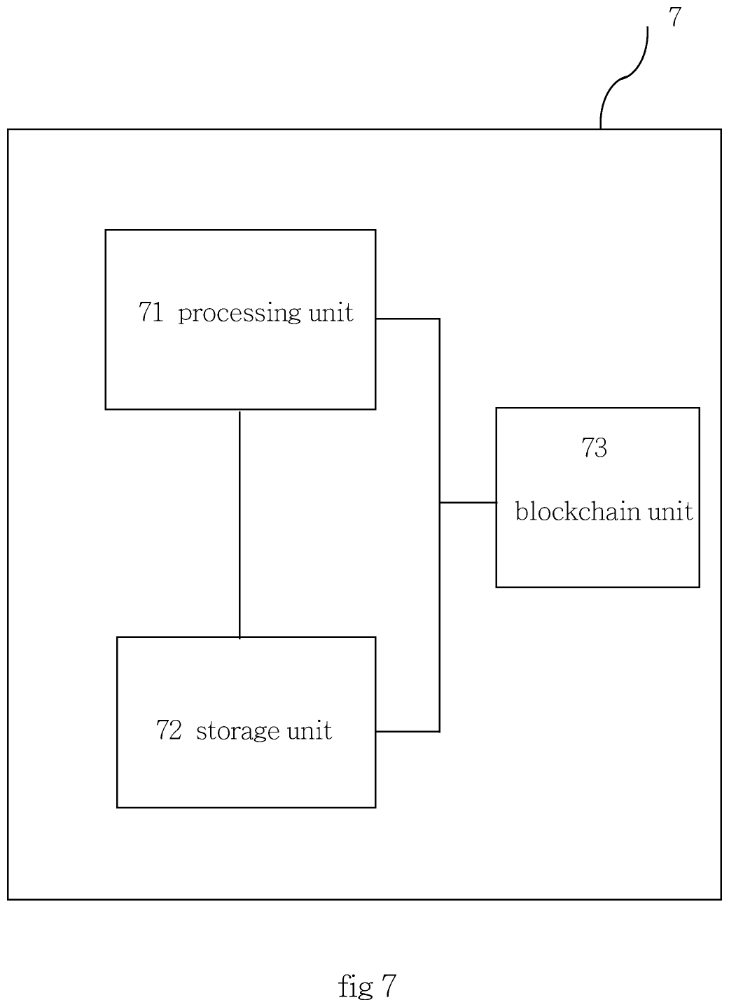

As shown in FIG. 7, it is a block diagram of a distributed financial flows auditing device 7 of the present invention, and the distributed financial flows auditing device 7 may comprise a processing unit 71 and a storage unit 72. A first indexed merkle tree related to an user may be created by the processing unit 71 as mentioned above, and the first indexed merkle tree is a balance information of a physical currency exchange receipt or a balance information of a virtual currency. A second indexed merkle tree related to a to-be-audited information of a trade related to the balance information is created by the processing unit 71. The balance information and the to-be-audited information are compared by the processing unit 71. The processing unit 71 may be a circuit, a chip, a central processor, micro processor (MCU) or the combination thereof, but the present invention is not limited.

The processing unit 71 may be coupled to a storage unit 72 as mentioned above, and the first indexed merkle tree and the second indexed merkle tree are stored by the storage unit 72. The storage unit 72 may be a CD-RW, a hard disk, a soft disk, an Universal Serial Bus (USB), a DRAM, a Flash, an electrically-erasable programmable read-only memory (EEPROM), an erasable programmable read only memory (EPROM) etc., but the present invention is not limited.

Additionally, comparing the balance information and the to-be-audited information by the processing unit 71 may be a comparison between a first slice and a second slice, and the to-be-audited information may be at least corresponding to a contract, and the contract is processed by the processing unit 71, the contract is stored by the storage unit 72. Furthermore, the user may trade with a market intermediary according to the contract, and the market intermediary commands the processing unit 71 to update the first indexed merkle tree and the second indexed merkle tree after the trade. An evidence information is created to the contract by the processing unit 71 when a result comparing the balance information and the to-be-audited information by the processing unit 71 the user commanded thereof is abnormal. In addition, the evidence information is stored by the storage unit 72. When the processing unit 71 is commanded to update the first indexed merkle tree and the second indexed merkle tree by the market intermediary, a condition that a first root hash value corresponding to the first indexed merkle tree and a second root hash value corresponding to the second indexed merkle tree are created by the processing unit 71 is included. In addition, the market intermediary commands the processing unit 71 to update the contract by the first root hash value and the second root hash value.

Further, a communication protocol is existed between the user and the market intermediary, and an evidence protocol is existed between the plurality of the users when the quantities of the users are plural. The communication protocol and the evidence protocol are processed by the processing unit 71, and the communication protocol and the evidence protocol are stored by the storage unit 72. The first indexed merkle tree and the second indexed merkle tree are updated by the processing unit 71 the market intermediary commands thereof in the condition a part of the quantities of the trades is a stage when the quantities of the trades are plural. The first indexed merkle tree and the second indexed merkle tree updated are stored by the storage unit 72. A settlement protocol is existed at least between the first indexed merkle tree and the second indexed merkle tree when each of the stages is completed. The settlement protocol is processed by the processing unit 71 and the settlement protocol is stored by the storage unit 72.

The contract as mentioned above may include a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract. The function of the contract as mentioned above may include a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

The communication protocol as mentioned above may include a transfer trade, a deposit trade and a withdraw trade. In detail, the steps of the transfer trade may include the following steps. (1) The processing unit 71 is commanded to transmit T_{Rmit}=((LSN, Remittance, Ui, Uj, X, stage serial number), SIG_{Pri(Ui)}) to the market intermediary by the user. LSN is an unrepeatable random number created by the user, and SIG_{Pri(Ui)} is an electronic signature of a message body signed by the user. (2) The processing unit 71 is commanded to modify the balance of the physical currency exchange receipt or the virtual currency of the different user (Ui,Uj) in the first indexed merkle tree by the market intermediary. The balance of the physical currency exchange receipt or the virtual currency of Ui and Uj is assumed as p,q respectively after transferring. (3) The processing unit 71 is commanded to reply T_{ACK}=((T_{Rmit}, p, q, GSN), SIG_{Pri(Agent)}) to the user Ui by the market intermediary. GSN is an integer created by the market intermediary and GSN is started from 0. GSN is added by 1 after every trade of the user is processed by the processing unit 71. SIG_{Pri(Agent)} is the electronic signature of the message body signed by the market intermediary. (4) The processing unit 71 is commanded to store the T_{ACK} into the second indexed merkle tree by the market intermediary.

The steps of the deposit trade may include the following steps. (1) The processing unit 71 is commanded to transmit T_{Deposit}=((LSN, Deposit, X, stage serial number), SIG_{Pri(Ui)} to the market intermediary by the user(Ui). LSN is an unrepeatable random number created by the user. SIG_{Pri(Ui)} is an electronic signature of a message body signed by the user. (2) The processing unit 71 is commanded to modify the balance of the user in the first indexed merkle tree by the market intermediary. The balance of the physical currency exchange receipt or the virtual currency of the user is assumed as p after transferring. (3) The processing unit 71 is commanded to perform Deposit_token_to_sidechain( ) of the contract by the market intermediary. Ui.balance of the contract is decreased by X by Deposit_token_to_sidechain( ) while a record:(Deposit, Ui, X, stage serial number, GSN) is added to the financial flows record. (4) The processing unit 71 is commanded to reply T_{ACK}=((T_{Deposit}, p, GSN), SIG_{Pri(Agent)})) to the user by the market intermediary. GSN is an integer created by the market intermediary, and GSN is started from 0. GSN is added by 1 after every trade of the user is processed by the processing unit 71. SIG_{Pri(Agent)} is the electronic signature of the message body signed by the market intermediary. (5) The processing unit 71 is commanded to store T_{ACK} into the second indexed merkle tree by the market intermediary.

Additionally, the steps of the withdraw trade may include the following steps. (1) The processing unit 71 is commanded to transmit T_{Withdraw}=((LSN, Withdraw, X, stage serial number), SIG_{Pri(Ui)} to the market intermediary by the user(Ui). LSN is an unrepeatable random number created by the user. SIG_{Pri(Ui)} is an electronic signature of a message body signed by the user. (2) The processing unit 71 is commanded to modify the balance of the user in the first indexed merkle tree by the market intermediary. The balance of the physical currency exchange receipt or the virtual currency of the user is assumed as p after transferring. (3) The processing unit 71 is commanded to perform Withdraw_token_from_sidechain( ) of the contract by the market intermediary. Ui.balance of the contract is added by X by Withdraw_token_from_sidechain( ) while a record: (Withdraw, Ui, X, stage serial number, GSN) is added to the financial flows record. (4) The processing unit 71 is commanded to reply T_{ACK}=((T_{Withdraw}, p, GSN), SIG_{Pri(Agent)}) to the user by the market intermediary. GSN is an integer created by the market intermediary, and GSN is started from 0. GSN is added by 1 after every trade of the user is processed by the processing unit 71. SIG_{Pri(Agent)} is the electronic signature of the message body signed by the market intermediary. (5) The processing unit 71 is commanded to store T_{ACK} into the second indexed merkle tree by the market intermediary.

Furthermore, the contract may further include a function Finalize( ). The processing unit 71 is commanded to perform Finalize( ) by the market intermediary in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

The contract as mentioned above may have a function Fraud_proof( ) in order to create the evidence information. The evidence information may be created in the following conditions or the combination thereof. (1) The market intermediary does not store the trade into the second indexed merkle tree after a transfer trade, a deposit trades or a withdraw trades is processed by the processing unit 71. The processing unit 71 is commanded to perform a Fraud_proof( ) function by the user in order to extract T_{ACK} returned from the market intermediary and a slice of the second indexed merkle tree used for proving the market intermediary do not store the trade into the second indexed merkle tree. (2) The market intermediary calculates a wrong balance of the user after the transfer trade, the deposit trade or the withdraw trade are processed by the processing unit 71. Because GSN is existed in all T_{ACK} returned from the market intermediary in every trade and a GSN value is increasing and unrepeatable, the processing unit 71 is commanded to sequence the plurality of the trades and find out the returned T_{ACK} of the previous one trade from the market intermediary by the user before the wrong trade Then the processing unit 71 is commanded to perform Fraud_proof( ) function by the user. An evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

Otherwise, the first indexed merkle tree and the second indexed merkle tree may be corresponding to a blockchain. In practice, the blockchain may be coupled to the distributed financial flows auditing device 7 of the present invention form an external or the blockchain may be a blockchain unit 73 included by the distributed financial flows auditing device 7, and the blockchain unit 73 may be at least coupled to the processing unit 71.

It shall be noted that the other content of the distributed financial flows auditing device 7 in the present invention has been descript in the foregoing paragraphs, and no longer to repeat. In addition, a command the processing unit 71 performed and commanded by the user or the market intermediary may be input into the distributed financial flows auditing device 7 directly by the user or the market intermediary. Or the command may be input into the distributed financial flows auditing device 7 through an external device. Furthermore, the coupling may be a coupling form transferring a signal or command by an electrical coupling, a quantum coupling and/or an optical coupling etc.

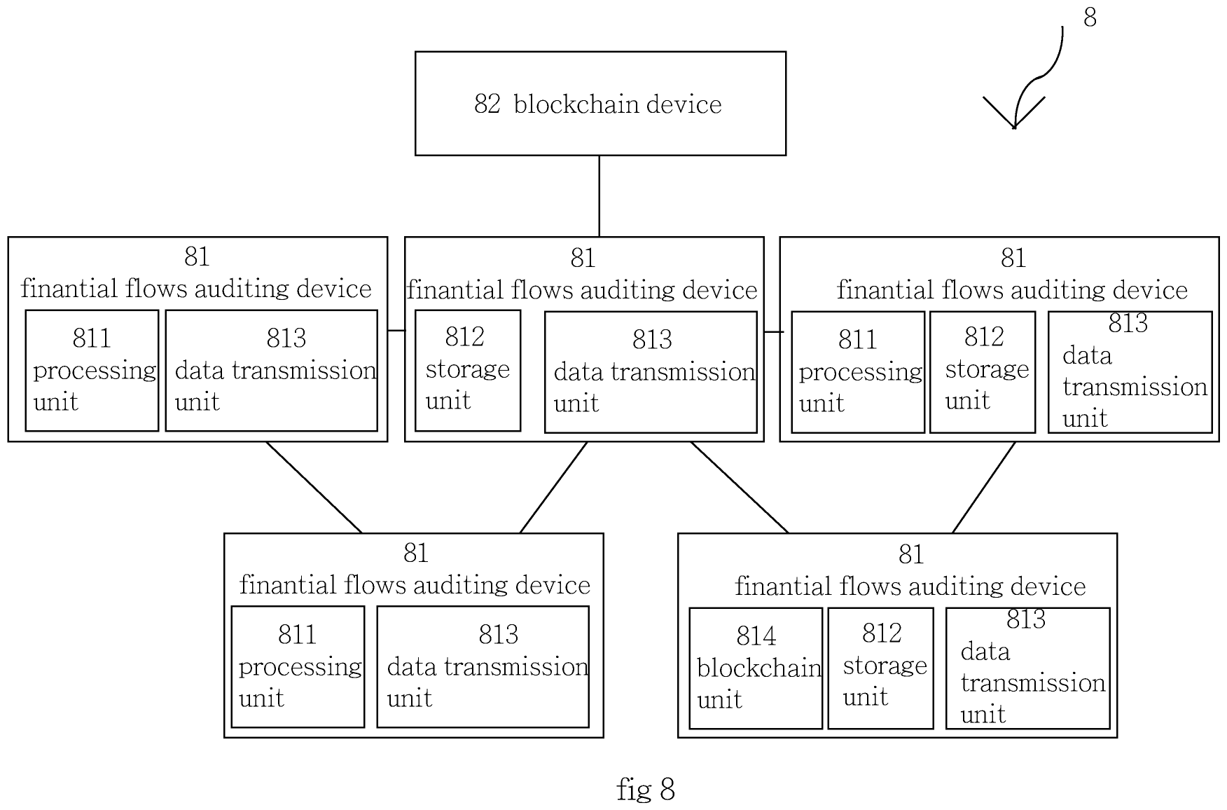

As shown in FIG. 8, it is a block diagram of a distributed financial flows auditing system 8 of the present invention, and the distributed financial flows auditing system 8 may comprise a plurality of financial flows auditing devices 81. At least one of the plurality of financial flows auditing devices 81 as mentioned above may include a processing unit 811 or a storage unit 812. Each one of the plurality of financial flows auditing devices 81 has a data transmission unit 813. A first indexed merkle tree related to an user is created by the processing unit 811, and the first indexed merkle tree is a balance information of a physical currency exchange receipt or a balance information of a virtual currency. A second indexed merkle tree related to a to-be-audited information of a trade related to the balance information is created by the processing unit 811, and the balance information, the to-be-audited information or the combination thereof is compared by the processing unit 811. At least a part of information corresponding to the first indexed merkle tree, at least a part of information corresponding to the second indexed merkle tree, a comparison result between the balance information and the to-be-audited information and the combination thereof are transmitted by the data transmission unit 813. The storage unit 812 is coupled to the processing unit 811 or the data transmission unit 813 in order to store the first indexed merkle tree or the second indexed merkle tree. In the condition of a decentralized computing architecture or a cloud computing,

The financial flows auditing device 81 may not have the processing unit 811 or storage unit 812 at the same time, or the financial flows auditing device 81 may not have the processing unit 811 or storage unit 812 with the function of the distributed financial flows auditing system 8 as mentioned above. The financial flows auditing device 81 may have the data transmission unit 813 in order to provide the operation of the distributed financial flows auditing system 8. The first indexed merkle tree, the second indexed merkle tree, the comparison between the balance information and the to-be-audited information or the combination thereof may be performed in the different processing unit 811. The first indexed merkle tree and the second indexed merkle tree may be stored into the different storage unit 812.

Additionally, the first indexed merkle tree may include a first slice, and the second indexed merkle tree may include a second slice. Further, comparing the balance information and the to-be-audited information by the processing unit 811 may compare the first slice and the second slice. The to-be-audited information may be at least corresponding to a contract, and the contract is processed by the at least one processing unit 811, and the contract is stored by the at least one storage unit 812.

In another aspect of the present invention, the user trades with a market intermediary according to the contract, and the market intermediary commands the at least one processing unit 811 to update the first indexed merkle tree and the second indexed merkle tree after the trade. An evidence information is created to the contract by the at least one processing unit 811 when a result comparing the balance information and the to-be-audited information by the at least one processing unit 811 the user commanded thereof is abnormal, and the evidence information is stored by the at least one storage unit 812.

In practice, a communication protocol is existed between the user and the market intermediary, and an evidence protocol is existed between the plurality of the users when the quantities of the users are plural. The communication protocol and the evidence protocol are processed by the at least one processing unit 811, and the communication protocol and the evidence protocol are stored by the at least one storage unit 812. The first indexed merkle tree and the second indexed merkle tree are updated by the at least one processing unit 811 the market intermediary commands thereof in the condition a part of the quantities of the trades is a stage when the quantities of the trades are plural. The first indexed merkle tree and the second indexed merkle tree updated are stored by the at least one storage unit 812, and a settlement protocol is existed at least between the first indexed merkle tree and the second indexed merkle tree when each of the stages is completed. The settlement protocol is processed by the at least one processing unit 811, and the settlement protocol is stored by the at least one storage unit 812. The communication protocol may include a transfer trades, a deposit trades and a withdraw trades.

Additionally, the contract may include a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

The steps of the transfer trade as mentioned above may include the following steps. (1) The at least one processing unit 811 is commanded to transmit T_{Rmit}=((LSN, Remittance, Ui, Uj, X, stage serial number), SIG_{Pri(Ui)} to the market intermediary by the user, LSN is an unrepeatable random number created by the user. SIG_{Pri(Ui)} is an electronic signature of a message body signed by the user. (2) The at least one processing unit 811 is commanded to modify the balance of the physical currency exchange receipt or the virtual currency of the different user(Ui,Uj) in the first indexed merkle tree by the market intermediary. The balance of the physical currency exchange receipt or the virtual currency of Ui and Uj is assumed as p,q respectively after transferring. (3) The at least one processing unit 811 is commanded to reply T_{ACK}=((T_{Rmit}, p, q, GSN), SIG_{Pri(Agent)}) to the user Ui by the market intermediary. GSN is an integer created by the market intermediary and GSN is started from 0. GSN is added by 1 after every trade of the user is processed by the at least one processing unit 811. SIG_{Pri(Agent)} is the electronic signature of the message body signed by the market intermediary. (4) The at least one processing unit 811 is commanded to store the T_{ACK} into the second indexed merkle tree by the market intermediary.

The steps of the deposit trade include as mentioned above may include the following steps. (1) The at least one processing unit 811 is commanded to transmit T_{Deposit}=((LSN, Deposit, X, stage serial number), SIG_{Pri(Ui)}) to the market intermediary by the user(Ui). LSN is an unrepeatable random number created by the user. SIG_{Pri(Ui)} is an electronic signature of a message body signed by the user. (2) The at least one processing unit 811 is commanded to modify the balance of the user in the first indexed merkle tree by the market intermediary. The balance of the physical currency exchange receipt or the virtual currency of the user is assumed as p after transferring. (3) The at least one processing unit 811 is commanded to perform Deposit_token_to_sidechain( ) of the contract by the market intermediary. Ui.balance of the contract is decreased by X by Deposit_token_to_sidechain( ) while a record:(Deposit, Ui, X, stage serial number, GSN) is added to the financial flows record. (4) The at least one processing unit 811 is commanded to reply T_{ACK}=((T_{Deposit}, p, GSN), SIG_{Pri(Agent)})) to the user by the market intermediary. GSN is an integer created by the market intermediary and GSN is started from 0. GSN is added by 1 after every trade of the user is processed by the at least one processing unit. SIG_{Pri(Agent)} is the electronic signature of the message body signed by the market intermediary. (4) The at least one processing unit 811 is commanded to store T_{ACK} into the second indexed merkle tree by the market intermediary.

The steps of the withdraw trade as mentioned above may include the following steps. (1) The at least one processing unit 811 is commanded to transmit T_{Withdraw}=((LSN, Withdraw, X, stage serial number), SIG_{Pri(Ui)}) to the market intermediary by the user(Ui). LSN is an unrepeatable random number created by the user. SIG_{Pri(Ui)} is an electronic signature of a message body signed by the user. (2) The at least one processing unit 811 is commanded to modify the balance of the user in the first indexed merkle tree by the market intermediary. The balance of the physical currency exchange receipt or the virtual currency of the user is assumed as p after transferring. (3) The at least one processing unit 811 is commanded to perform Withdraw_token_from_sidechain( ) of the contract by the market intermediary. Ui.balance of the contract is added by X by Withdraw_token_from_sidechain( ) while a record: (Withdraw, Ui, X, stage serial number, GSN) is added to the financial flows record. (4) The at least one processing unit 811 is commanded to reply T_{ACK}=((T_{Withdraw}, p, GSN), SIG_{Pri(Agent)}) to the user by the market intermediary. GSN is an integer created by the market intermediary and GSN is started from 0. GSN is added by 1 after every trade of the user is processed by the at least one processing unit 811. SIG_{Pri(Agent)} is the electronic signature of the message body signed by the market intermediary. (5) The at least one processing unit 811 is commanded to store T_{ACK} into the second indexed merkle tree by the market intermediary.

Additionally, the contract further includes a function Finalize( ) the at least one processing unit 811 is commanded to perform Finalize( ) by the market intermediary in order to store a hash value of the first indexed merkle tree and the second indexed merkle tree after a present stage is completed into the contract and publish thereof. While the market intermediary publishes at least a part of the first indexed merkle tree and at least a part of the second indexed merkle tree used for query after the present stage is completed.

Furthermore, the contract has a function Fraud_proof( ) in order to create the evidence information. The evidence information is created in the following conditions or the combination thereof. (1) The market intermediary does not store the trade into the second indexed merkle tree after a transfer trade, a deposit trades or a withdraw trades is processed by the at least one processing unit 811. The at least one processing unit 811 is commanded to perform a Fraud_proof( ) function by the user in order to extract T_{ACK} returned from the market intermediary and a slice of the second indexed merkle tree used for proving the market intermediary do not store the trade into the second indexed merkle tree. (2) The market intermediary calculates a wrong balance of the user after the transfer trade, and the deposit trade or the withdraw trade are processed by the at least one processing unit 811. Because GSN is existed in all T_{ACK} returned from the market intermediary in every trade and a GSN value is increasing and unrepeatable, the at least one processing unit 811 is commanded to sequence the plurality of the trades and find out the returned T_{ACK} of the previous one trade from the market intermediary by the user before the wrong trade. Then the at least one processing unit 811 is commanded to perform Fraud_proof( ) function by the user. An evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

Further, commanding the at least one processing unit 811 to update the first indexed merkle tree and the second indexed merkle tree by the market intermediary may include that a first root hash value corresponding to the first indexed merkle tree is created by the at least one processing unit 811 and a second root hash value corresponding to the second indexed merkle tree is created by the at least one processing unit 811. In addition, the first root hash value and the second root hash value are used for updating the contract by the at least one processing unit 811 the market intermediary commands.

In another aspect of the present invention, the distributed financial flows auditing system 8 of the present invention may further comprise a blockchain device 82 or a blockchain unit 814. The blockchain device 82 is coupled to the at least one financial flows auditing device 81, and the blockchain unit 814 is provided to the at least one financial flows auditing device 81. The first indexed merkle tree and the second indexed merkle tree may be at least corresponding to a blockchain in the blockchain device 82 or a blockchain in the blockchain unit 814.

In conclusion, the to-be-audited information may be the integrated to-be-audited information of a plurality of trades, therefore the present invention can save the cost of time, frequency, fee etc. used for transmitting the to-be-audited information. Additionally, the collateral compensates the user through providing a collateral by the market intermediary when a result comparing the balance information and the to-be-audited information by the user is abnormal, therefore a credibility of the present invention is promoted. Furthermore, the present invention is able to achieve a low-burden and high efficiency system through comparing the slice of the original account book (to-be-audited information) by the user. In addition, the present invention is able to establish the multiple to multiple trade channel between the plurality of the users and between the plurality of the users and the at least one market intermediary in order to support a general micropayments used for the physical currency exchange receipt or the virtual currency.

The above describes the preferred embodiments of the present invention. However, not all of the elements or steps are essential technical features, and all details of the technical features may not have been described completely. All units and steps described are provided as examples only, and they may be modified by a person ordinarily skilled in the art of the technical field of this patent application. The scope of the present invention shall be defined by the claims thereof.

What is claimed is:

1. A distributed financial flows auditing method, comprising:
providing a balance information of a physical currency exchange receipt or a balance information of a virtual currency related to an user and stored as a first indexed merkle tree, and providing a to-be-audited information of a trade related to the balance information and stored as a second indexed merkle tree; and
the user compares the balance information and the to-be-audited information.

2. The distributed financial flows auditing method according to claim 1, wherein, the to-be-audited information is at least corresponding to a contract.

3. The distributed financial flows auditing method according to claim 2, wherein, the user trades with a market intermediary according to the contract, and the market intermediary updates the first indexed merkle tree and the second indexed merkle tree after the trade, an evidence information is created to the contract when a result comparing the balance information and the to-be-audited information by the user is abnormal.

4. The distributed financial flows auditing method according to claim 3, wherein, a communication protocol is existed between the user and the market intermediary, and an evidence protocol is existed between the plurality of the users when the quantities of the users are plural, the market intermediary updates the first indexed merkle tree and the second indexed merkle tree by part of the quantities of the trades as a stage when the quantities of the trades are plural, and a settlement protocol is existed at least between the first indexed merkle tree and the second indexed merkle tree when each of the stages is completed.

5. The distributed financial flows auditing method according to claim 4, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

6. The distributed financial flows auditing method according to claim 5, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

7. The distributed financial flows auditing method according to claim 4, wherein, the communication protocol includes a transfer trade, a deposit trade and a withdraw trade.

8. The distributed financial flows auditing method according to claim 7, wherein, steps of the transfer trade include: the user transmits T_{Rmit}=((LSN, Remittance, Ui, Uj, X, stage serial number), SIG_{Pri(Ui)} to the market intermediary, LSN is an unrepeatable random number created by the user, SIG_{Pri(Ui)} is an electronic signature of a message body signed by the user; the market intermediary modifies the balance of the physical currency exchange receipt or the virtual currency of the different user(Ui,Uj) in the first indexed merkle tree, the balance of the physical currency exchange receipt or the virtual currency of Ui and Uj is assumed as p,q respectively after transferring; T_{ACK}=((T_{Rmit}, p, q, GSN), SIG_{Pri(Agent)}) is replied to the user Ui by the market intermediary, GSN is an integer created by the market intermediary and GSN is started from 0, GSN is added by 1 after every trade of the user is processed, SIG_{Pri(Agent)} is the electronic signature of the message body signed by the market intermediary; and the T_{ACK} is stored into the second indexed merkle tree by the market intermediary.

9. The distributed financial flows auditing method according to claim 7, wherein, steps of the deposit trade include: the user(Ui) transmits T_{Deposit}=((LSN, Deposit, X, stage serial number), SIG_{Pri(Ui)} to the market intermediary, LSN is an unrepeatable random number created by the user, SIG_{Pri(Ui)} is an electronic signature of a message body signed by the user; the market intermediary modifies the balance of the user in the first indexed merkle tree, the balance of the physical currency exchange receipt or the virtual currency of the user is assumed as p after transferring; the market intermediary commands Deposit_token_to_sidechain( ) of the contract to be performed, Ui.balance of the contract is decreased by X by Deposit_token_to_sidechain( ) while a record:(Deposit, Ui, X, stage serial number, GSN) is added to the financial flows record; T_{ACK}=((T_{Deposit}, p, GSN), SIG_{Pri(Agent)})) is replied to the user by the market intermediary, GSN is an integer created by the market intermediary and GSN is started from 0, GSN is added by 1 after every trade of the user is processed, SIG_{Pri(Agent)} is the electronic signature of the message body signed by the market intermediary; and the T_{ACK} is stored into the second indexed merkle tree by the market intermediary.

10. The distributed financial flows auditing method according to claim 7, wherein, steps of the withdraw trade include: the user(Ui) transmits T_{Withdraw}=((LSN, Withdraw, X, stage serial number), SIG_{Pri(Ui)}) to the market intermediary, LSN is an unrepeatable random number created by the user, SIG_{Pri(Ui)} is an electronic signature of a message body signed by the user; the market intermediary modifies the balance of the user in the first indexed merkle tree, the balance of the physical currency exchange receipt or the virtual currency of the user is assumed as p after transferring; the market intermediary commands Withdraw_token_from_sidechain( ) of the contract to be performed, Ui.balance of the contract is added by X by Withdraw_token_from_sidechain( ) while a record: (Withdraw, Ui, X, stage serial number, GSN) is added to the financial flows record; TACK=((TWithdraw, p, GSN), SIGPri(Agent)) is replied to the user by the market intermediary, GSN is an integer created by the market intermediary and GSN is started from 0, GSN is added by 1 after every trade of the user is processed, SIGPri(Agent) is the electronic signature of the message body signed by the market intermediary; and the TACK is stored into the second indexed merkle tree by the market intermediary.

11. The distributed financial flows auditing method according to claim 5, wherein, the contract further includes a function Finalize( ), the market intermediary performs Finalize( ) in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

12. The distributed financial flows auditing method according to claim 6, wherein, the contract has a function Fraud_proof( ) in order to create the evidence information, the evidence information is created in the following conditions or the combination thereof: (1) the market intermediary does not store the trade into the second indexed merkle tree after processing a transfer trade, a deposit trade or a withdraw trade, the user performs a Fraud_proof( ) function in order to extract T_{ACK} returned from the market intermediary and a slice of the second indexed merkle tree used for proving the market intermediary do not store the trade into the second indexed merkle tree; (2) the market intermediary calculates a wrong balance of the user after processing the transfer trades, the deposit trades or the withdraw trades, because GSN is existed in all T_{ACK} returned from the market intermediary in every trade and a GSN value is increasing and unrepeatable, the user sequences the plurality of the trades and finds out the returned T_{ACK} of the previous one trade from the market intermediary before the wrong trade, then the user performs Fraud_proof( ) function in order to create an evidence by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

13. The distributed financial flows auditing method according to claim 1, wherein, the first indexed merkle tree and the second indexed merkle tree are corresponding to a blockchain.

14. A distributed financial flows auditing device, comprising:
a processing unit creating a first indexed merkle tree related to an user, and the first indexed merkle tree is a balance information of a physical currency exchange receipt or a balance information of a virtual currency, and a second indexed merkle tree related to a to-be-audited information of a trade related to the balance information is created by the processing unit, and the balance information and the to-be-audited information are compared by the processing unit; and
a storage unit coupling to the processing unit, and the first indexed merkle tree and the second indexed merkle tree are stored by the storage unit.

15. The distributed financial flows auditing device according to claim 14, wherein, the to-be-audited information is at least corresponding to a contract, and the contract is processed by the processing unit, the contract is stored by the storage unit.

16. The distributed financial flows auditing device according to claim 15, wherein, the user trades with a market intermediary according to the contract, and the market intermediary commands the processing unit to update the first indexed merkle tree and the second indexed merkle tree after the trade, an evidence information is created to the contract by the processing unit when a result comparing the balance information and the to-be-audited information by the processing unit the user commanded thereof is abnormal, and the evidence information is stored by the storage unit.

17. The distributed financial flows auditing device according to claim 16, wherein, a communication protocol is existed between the user and the market intermediary, and an evidence protocol is existed between the plurality of the users when the quantities of the users are plural, the communication protocol and the evidence protocol are processed by the processing unit, and the communication protocol and the evidence protocol are stored by the storage unit, the first indexed merkle tree and the second indexed merkle tree are updated by the processing unit the market intermediary commands thereof in the condition a part of the quantities of the trades is a stage when the quantities of the trades are plural, the first indexed merkle tree and the second indexed merkle tree updated are stored by the storage unit, and a settlement protocol is existed at least between the first indexed merkle tree and the second indexed merkle tree when each of the stages is completed, the settlement protocol is processed by the processing unit and the settlement protocol is stored by the storage unit.

18. The distributed financial flows auditing device according to claim 17, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

19. The distributed financial flows auditing device according to claim 18, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

20. The distributed financial flows auditing device according to claim 17, wherein, the communication protocol includes a transfer trade, a deposit trade and a withdraw trade.

21. The distributed financial flows auditing device according to claim 20, wherein, steps of the transfer trade include: the processing unit is commanded to transmit T_{Rmit}=((LSN, Remittance, Ui, Uj, X, stage serial number), SIG_{Pri(Ui)}) to the market intermediary by the user, LSN is an unrepeatable random number created by the user, SIG_{Pri(Ui)} is an electronic signature of a message body signed by the user; the processing unit is commanded to modify the balance of the physical currency exchange receipt or the virtual currency of the different user(Ui,Uj) in the first indexed merkle tree by the market intermediary, the balance of the physical currency exchange receipt or the virtual currency of Ui and Uj is assumed as p,q respectively after transferring; the processing unit is commanded to reply T_{ACK}=((T_{Rmit}, p, q, GSN), SIG_{Pri(Agent)}) to the user Ui by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store the T_{ACK} into the second indexed merkle tree by the market intermediary.

22. The distributed financial flows auditing device according to claim 20, wherein, steps of the deposit trade include: the processing unit is commanded to transmit T_{Deposit}=((LSN, Deposit, X, stage serial number), SIG_{Pri(Ui)} to the market intermediary by the user(Ui), LSN is an unrepeatable random number created by the user, SIG_{Pri(Ui)} is an electronic signature of a message body signed by the user; the processing unit is commanded to modify the balance of the user in the first indexed merkle tree by the market intermediary, the balance of the physical currency exchange receipt or the virtual currency of the user is assumed as p after transferring; the processing unit is commanded to perform Deposit_token_to_sidechain( ) of the contract by the market intermediary, Ui.balance of the contract is decreased by X by Deposit_token_to_sidechain( ) while a record:(Deposit, Ui, X, stage serial number, GSN) is added to the financial flows record; the processing unit is commanded to reply T_{ACK}=((T_{Deposit}, p, GSN), SIG_{Pri(Agent)})) to the user by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store T_{ACK} into the second indexed merkle tree by the market intermediary.

23. The distributed financial flows auditing device according to claim 20, wherein, steps of the withdraw trade include: the processing unit is commanded to transmit T_{Withdraw}=((LSN, Withdraw, X, stage serial number), SIG_{Pri(Ui)} to the market intermediary by the user(Ui), LSN is an unrepeatable random number created by the user, SIG_{Pri(Ui)} is an electronic signature of a message body signed by the user; the processing unit is commanded to modify the balance of the user in the first indexed merkle tree by the market intermediary, the balance of the physical currency exchange receipt or the virtual currency of the user is assumed as p after transferring; the processing unit is commanded to perform Withdraw_token_from_sidechain( ) of the contract by the market intermediary, Ui.balance of the contract is added by X by Withdraw_token_from_sidechain( ) while a record: (Withdraw, Ui, X, stage serial number, GSN) is added to the financial flows record; the processing unit is commanded to reply T_{ACK}=((T_{Withdraw}, p, GSN), SIG_{Pri(Agent)}) to the user by the market intermediary, GSN is an integer created by the market intermediary and GSN is started from 0, GSN is added by 1 after every trade of the user is processed by the processing unit, SIG_{Pri(Agent)} is the electronic signature of the message body signed by the market intermediary; and the processing unit is commanded to store T_{ACK} into the second indexed merkle tree by the market intermediary.

24. The distributed financial flows auditing device according to claim 18, wherein, the contract further includes a function Finalize( ), the processing unit is commanded to perform Finalize( ) by the market intermediary in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

25. The distributed financial flows auditing device according to claim 19, wherein, the contract has a function Fraud_proof( ) in order to create the evidence information, the evidence information is created in the following conditions or the combination thereof: (1) the market intermediary does not store the trade into the second indexed merkle tree after a transfer trade, a deposit trades or a withdraw trades is processed by the processing unit, the processing unit is commanded to perform a Fraud_proof( ) function by the user in order to extract T_{ACK} returned from the market intermediary and a slice of the second indexed merkle tree used for proving the market intermediary do not store the trade into the second indexed merkle tree; (2) the market intermediary calculates a wrong balance of the user after the transfer trade, the deposit trade or the withdraw trade are processed by the processing unit, because GSN is existed in all T_{ACK} returned from the market intermediary in every trade and a GSN value is increasing and unrepeatable, the processing unit is commanded to sequence the plurality of the trades and find out the returned T_{ACK} of the previous one trade from the market intermediary by the user before the wrong trade, then the processing unit is commanded to perform Fraud_proof( ) function by the user, an evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

26. The distributed financial flows auditing device according to claim 14, wherein, the first indexed merkle tree and the second indexed merkle tree are corresponding to a blockchain.

27. A distributed financial flows auditing system, comprising:
a plurality of financial flows auditing devices, and at least one of the plurality of financial flows auditing devices includes a processing unit or a storage unit, each one of the financial flows auditing devices has a data transmission unit, and a first indexed merkle tree related to an user is created by the at least one processing unit, and the first indexed merkle tree is a balance information of a physical currency exchange receipt or a balance information of a virtual currency, and a second indexed merkle tree related to a to-be-audited information of a trade related to the balance information is created by the at least one processing unit, and the balance information, the to-be-audited information or the combination thereof is compared by the at least one processing unit, and at least a part of a information corresponding to the first indexed merkle tree, at least a part of a information corresponding to the second indexed merkle tree, a comparison result between the balance information and the to-be-audited information and the combination thereof are transmitted by the data transmission unit, the storage unit is coupled to the processing unit or the data transmission unit in order to store the first indexed merkle tree or the second indexed merkle tree.

28. The distributed financial flows auditing system according to claim 27, wherein, the to-be-audited information is at least corresponding to a contract, and the contract is processed by the at least one processing unit, the contract is stored by the at least one storage unit.

29. The distributed financial flows auditing system according to claim 28, wherein, the user trades with a market intermediary according to the contract, and the market intermediary commands the at least one processing unit to update the first indexed merkle tree and the second indexed merkle tree after the trade, an evidence information is created to the contract by the at least one processing unit when a result comparing the balance information and the to-be-audited information by the at least one processing unit the user commanded thereof is abnormal, and the evidence information is stored by the at least one storage unit.

30. The distributed financial flows auditing system according to claim 29, wherein, a communication protocol is existed between the user and the market intermediary, and an evidence protocol is existed between the plurality of the users when the quantities of the users are plural, the communication protocol and the evidence protocol are processed by the at least one processing unit, and the communication protocol and the evidence protocol are stored by the at least one storage unit, the first indexed merkle tree and the second indexed merkle tree are updated by the at least one processing unit the market intermediary commands thereof in the condition a part of the quantities of the trades is a stage when the quantities of the trades are plural, the first indexed merkle tree and the second indexed merkle tree updated are stored by the at least one storage unit, and a settlement protocol is existed at least between the first indexed merkle tree and the second indexed merkle tree when each of the stages is completed, the settlement protocol is processed by the at least one processing unit, and the settlement protocol is stored by the at least one storage unit.

31. The distributed financial flows auditing system according to claim 30, wherein, the contract includes a collateral of the market intermediary, the physical currency exchange receipt or the virtual the currency of the user, a deposit record of the physical currency exchange receipt or the virtual the currency of the user, a financial flows record between the contract and the first indexed merkle tree and between the contract and the second indexed merkle tree, a serial number of the plurality of the stages, a hash value of the plurality of the stages of the first indexed merkle tree and the second indexed merkle tree and a function of the contract.

32. The distributed financial flows auditing system according to claim 31, wherein, the function of the contract includes a function depositing the physical currency exchange receipt or the virtual currency of the user to the contract, a function transferring the physical currency exchange receipt or the virtual currency of the user in the contract, a function transferring the physical currency exchange receipt or the virtual currency of the user in the contract to the first indexed merkle tree, a function transferring at least part of the balance of the physical currency exchange receipt or the virtual currency in the first indexed merkle tree to the contract, a function completing the one stage and performing a settlement and a function creating the evidence information.

33. The distributed financial flows auditing system according to claim 30, wherein, the communication protocol includes a transfer trade, a deposit trade and a withdraw trade.

34. The distributed financial flows auditing system according to claim 33, wherein, steps of the transfer trade include: the at least one processing unit is commanded to transmit T_{Rmit}=((LSN, Remittance, Ui, Uj, X, stage serial number), SIG_{Pri(Ui)}) to the market intermediary by the user, LSN is an unrepeatable random number created by the user, SIG_{Pri(Ui)} is an electronic signature of a message body signed by the user; the at least one processing unit is commanded to modify the balance of the physical currency exchange receipt or the virtual currency of the different user(Ui,Uj) in the first indexed merkle tree by the market intermediary, the balance of the physical currency exchange receipt or the virtual currency of Ui and Uj is assumed as p,q respectively after transferring; the at least one processing unit is commanded to reply T_{ACK}=((T_{Rmit}, p, q, GSN), SIG_{Pri(Agent)}) to the user Ui by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store the T_{ACK} into the second indexed merkle tree by the market intermediary.

35. The distributed financial flows auditing system according to claim 33, wherein, the steps of the deposit trade include: the at least one processing unit is commanded to transmit T_{Deposit}=((LSN, Deposit, X, stage serial number), SIG_{Pri(Ui)} to the market intermediary by the user(Ui), LSN is an unrepeatable random number created by the user, SIG_{Pri(Ui)} is an electronic signature of a message body signed by the user; the at least one processing unit is commanded to modify the balance of the user in the first indexed merkle tree by the market intermediary, the balance of the physical currency exchange receipt or the virtual currency of the user is assumed as p after transferring; the at least one processing unit is commanded to perform Deposit_token_to_sidechain( ) of the contract by the market intermediary, Ui.balance of the contract is decreased by X by Deposit_token_to_sidechain( ) while a record:(Deposit, Ui, X, stage serial number, GSN) is added to the financial flows record; the at least one processing unit is commanded to reply T_{ACK}=((T_{Deposit}, p, GSN), SIG_{Pri(Agent)})) to the user by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store T_{ACK} into the second indexed merkle tree by the market intermediary.

36. The distributed financial flows auditing system according to claim 33, wherein, the steps of the withdraw trade includes: the at least one processing unit is commanded to transmit T_{Withdraw}=((LSN, Withdraw, X, stage serial number), SIG_{Pri(Ui)}) to the market intermediary by the user(Ui), LSN is an unrepeatable random number created by the user, SIG_{Pri(Ui)} is an electronic signature of a message body signed by the user; the at least one processing unit is commanded to modify the balance of the user in the first indexed merkle tree by the market intermediary, the balance of the physical currency exchange receipt or the virtual currency of the user is assumed as p after transferring; the at least one processing unit is commanded to perform Withdraw_token_from_sidechain( ) of the contract by the market intermediary, Ui.balance of the contract is added by X by Withdraw_token_from_sidechain( ) while a record: (Withdraw, Ui, X, stage serial number, GSN) is added to the financial flows record; the at least one processing unit is commanded to reply T_{ACK}=((T_{Withdraw}, p, GSN), SIG_{Pri(Agent)}) to the user by the market intermediary, GSN is an integer created by the market intermediary and GSN is started from 0, GSN is added by 1 after every trade of the user is processed by the at least one processing unit, SIG_{Pri(Agent)} is the electronic signature of the message body signed by the market intermediary; and the at least one processing unit is commanded to store T_{ACK} into the second indexed merkle tree by the market intermediary.

37. The distributed financial flows auditing system according to claim 31, wherein, the contract further includes a function Finalize( ), the at least one processing unit is commanded to perform Finalize( ) by the market intermediary in order to store a hash value of the first indexed merkle tree and the second indexed merkle tree after a present stage is completed into the contract and publish thereof while the market intermediary publishes at least a part of the first indexed merkle tree and at least a part of the second indexed merkle tree used for query after the present stage is completed.

38. The distributed financial flows auditing system according to claim 32, wherein, the contract has a function Fraud_proof( ) in order to create the evidence information, the evidence information is created in the following conditions or the combination thereof: (1) the market intermediary does not store the trade into the second indexed merkle tree after a transfer trade, a deposit trades or a withdraw trades is processed by the at least one processing unit, the at least one processing unit is commanded to perform a Fraud_proof( ) function by the user in order to extract T_{ACK} returned from the market intermediary and a slice of the second indexed merkle tree used for proving the market intermediary do not store the trade into the second indexed merkle tree; (2) the market intermediary calculates a wrong balance of the user after the transfer trade, the deposit trade or the withdraw trade are processed by the at least one processing unit, because GSN is existed in all T_{ACK} returned from the market intermediary in every trade and a GSN value is increasing and unrepeatable, the at least one processing unit is commanded to sequence the plurality of the trades and find out the returned T_{ACK} of the previous one trade from the market intermediary by the user before the wrong trade, then the at least one processing unit is commanded to perform Fraud_proof( ) function by the user, an evidence is created by the wrong trade and the T_{ACK} returned from the market intermediary in the previous one trade, and the evidence is used for proving there is no GSN value of a trade between the GSN value of the present trade and the GSN value of the previous one trade extracted by the market intermediary in order to prove the market intermediary failed.

39. The distributed financial flows auditing system according to claim 27, further comprising a blockchain device or a blockchain unit, the blockchain device is coupled to the at least one financial flows auditing device, the blockchain unit is provided to the at least one financial flows auditing device, the first indexed merkle tree and the second indexed merkle tree is at least corresponding to a blockchain in the blockchain device or a blockchain in the blockchain unit.
